(19) United States
(12) Patent Application Publication
(10) Pub. No.: US 2020/0263994 A1
(43) Pub. Date: Aug. 20, 2020

(54) INFORMATION PROCESSING APPARATUS, INFORMATION PROCESSING METHOD, PROGRAM, AND MOVING BODY

(71) Applicant: Sony Corporation, Tokyo (JP)

(72) Inventors: Shun LEE, Saitama (JP); Akira FUKUI, Kanagawa (JP); Shinichiro ABE, Kanagawa (JP); Masahiko TOYOSHI, Tokyo (JP); Keitaro YAMAMOTO, Tokyo (JP)

(73) Assignee: Sony Corporation, Tokyo (JP)

(21) Appl. No.: 16/756,849

(22) PCT Filed: Oct. 11, 2018
(86) PCT No.: PCT/JP2018/037839

§ 371 Date: Apr. 17, 2020

(30) Foreign Application Priority Data
Oct. 25, 2017 (JP) 2017-205785

(51) Int. Cl. G01C 21/30; G08G 1/133; G08G 1/01; G09B 29/00

(52) U.S. Cl. CPC G01C 21/30; G09B 29/00; G08G 1/0125; G08G 1/133

(57) ABSTRACT

The present technology relates to an information processing apparatus, an information processing method, a program, and a moving body, which can improve accuracy of self-position estimation of a moving body.

The information processing apparatus includes a feature point detector that detects a feature point in a reference image used for self-position estimation of a moving body, an invariance estimating section that estimates invariance of the feature point, and a map generator that generates a map based on the feature point and the invariance of the feature point. The present technology is applicable to, for example, an apparatus or system, which performs self-position estimation of a moving body, or various kinds of moving bodies such as a vehicle.

### TECHNICAL FIELD

The present technology relates to an information processing apparatus, an information processing method, a program, and a moving body, and particularly to an information processing apparatus, an information processing method, a program, and a moving body, which are preferably used in a case where self-position estimation of the moving body is performed using a map based on an image.

### BACKGROUND ART

Conventionally, there has been proposed a technique for determining whether or not an object around a moving body is a movable object based on feature data of the object and information regarding an object attribute prepared in advance, and generating a map of environment excluding the movable object (e.g., refer to PTL 1).

### CITATION LIST

### Patent Literature

### [PTL 1]

Japanese Patent Laid-open No. 2014-203429

### SUMMARY

### Technical Problem

However, there are objects whose appearances or shapes change due to, for example, lapse of time, environment, or weather, other than the movable object. In a case where self-position estimation is performed based on information regarding those objects, estimation accuracy may disadvantageously be lowered.

The present technology is made in view of such a situation, and its object is to improve accuracy of self-position estimation of a moving body.

### Solution to Problem

An information processing apparatus according to a first aspect of the present technology includes a feature point detector that detects a feature point in a reference image used for self-position estimation of a moving body, an invariance estimating section that estimates invariance of the feature point, and a map generator that generates a map based on the feature point and the invariance of the feature point.

An information processing method according to the first aspect of the present technology includes detecting a feature point in a reference image used for self-position estimation of a moving body, estimating invariance of the feature point, and generating a map based on the feature point and the invariance of the feature point.

A program according to the first aspect of the present technology causes a computer to execute detecting a feature point in a reference image used for self-position estimation of a moving body, estimating invariance of the feature point, and generating a map based on the feature point and the invariance of the feature point.

A moving body according to a second aspect of the present technology includes a feature point detector that detects a feature point in an observed image, a feature point collation section that performs collation between a feature point in a map generated based on the feature point and invariance of the feature point and the feature point in the observed image, and a self-position estimating section that performs self-position estimation based on a collation result between the feature point in the map and the feature point in the observed image.

In the first aspect of the present technology, the feature point in the reference image used for the self-position estimation of the moving body is detected, the invariance of the feature point is estimated, and the map is generated based on the feature point and the invariance of the feature point.

In the second aspect of the present technology, the feature point in the observed image is detected, the collation between the feature point in the map generated based on the feature point and the invariance of the feature point and the feature point in the observed image is performed, and the self-position estimation is performed based on the collation result between the feature point in the map and the feature point in the observed image.

### Advantageous Effects of Invention

According to the first aspect of the present technology, the invariance of the map used for the self-position estimation of the moving body can be improved. As a result, accuracy of the self-position estimation of the moving body can be improved.

According to the second aspect of the present technology, accuracy of the collation between the feature point in the map and the feature point in the observed image can be improved. As a result, the accuracy of the self-position estimation of the moving body can be improved.

Note that the effects described here are not necessarily limited, and any effect described in the present disclosure may be included.

### BRIEF DESCRIPTION OF DRAWINGS

FIG. 1 is a block diagram illustrating a configuration example of schematic functions of a vehicle control system to which the present technology is applicable.

FIG. 2 is a block diagram illustrating one exemplary embodiment of a self-position estimating system to which the present technology is applied.

FIG. 3 is a flowchart for explaining a map generation process.

FIG. 4 is a table illustrating examples of invariance scores of feature points.

FIG. 5 is a view for explaining an invariance score setting method of the feature points.

FIG. 6 is a view for explaining the invariance score setting method of the feature points.

FIG. 7 is a view for explaining the invariance score setting method of the feature points.

FIG. 8 is a view for explaining the invariance score setting method of the feature points.

FIG. 9 is a view for explaining an invariance score calculation method of a reference image.

FIG. 10 is a view for explaining an extraction method of a reference image to be used for a key frame.

FIG. 11 is a flowchart for explaining a self-position estimating process.

FIG. 12 is a view for explaining a deleting method of the key frame.

FIG. 13 is a configuration example of a computer.

### DESCRIPTION OF EMBODIMENT

Hereinafter, an exemplary embodiment of the present technology will be described. The description will be made in the following order.

1. Configuration example of vehicle control system
2. Exemplary embodiment

### 3. Modifications

### 4. Others

### 1. Configuration Example of Vehicle Control System

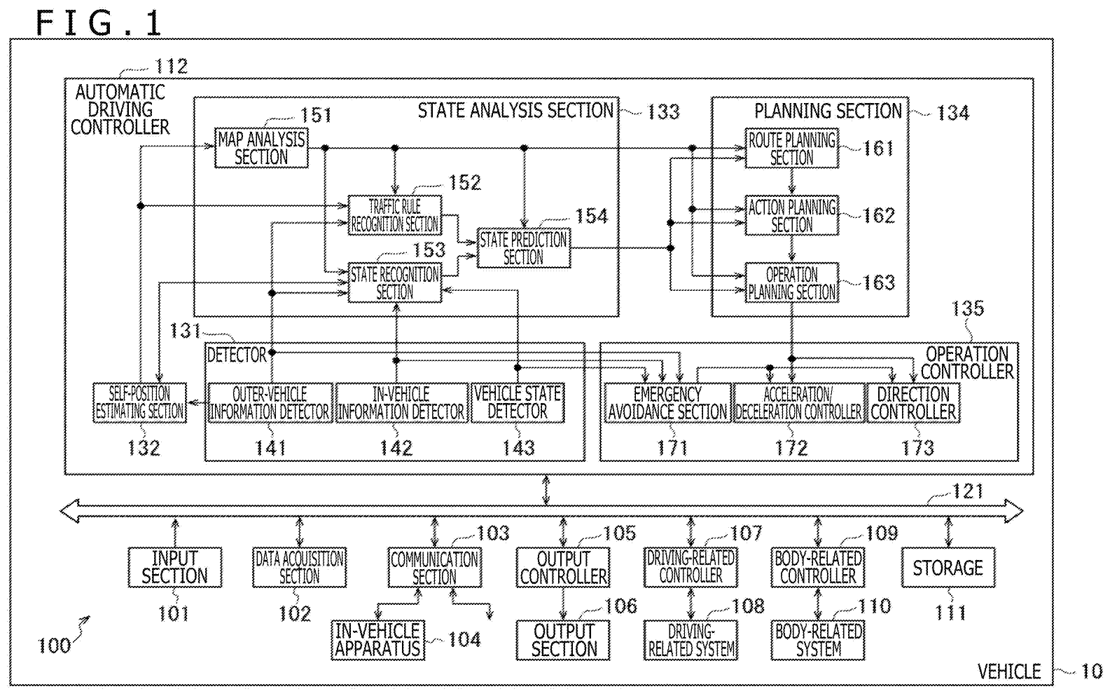

FIG. 1 is a block diagram illustrating a configuration example of schematic functions of a vehicle control system 100 as an example of a moving-body control system to which the present technology is applicable.

The vehicle control system 100 is a system that is mounted on a vehicle 10 and variously controls the vehicle 10. Note that, hereinafter, in a case where the vehicle 10 is discriminated from other vehicles, the vehicle 10 is referred to as a host car or a host vehicle.

The vehicle control system 100 includes an input section 101, a data acquisition section 102, a communication section 103, an in-vehicle apparatus 104, an output controller 105, an output section 106, a driving-related controller 107, a driving-related system 108, a body-related controller 109, a body-related system 110, a storage 111, and an automatic driving controller 112. The input section 101, the data acquisition section 102, the communication section 103, the output controller 105, the driving-related controller 107, the body-related controller 109, the storage 111, and the automatic driving controller 112 are mutually connected through a communication network 121. The communication network 121 includes, for example, an on-vehicle communication network conforming to any standard such as CAN (Controller Area Network), LIN (Local Interconnect Network), LAN (Local Area Network), or FlexRay (registered trademark), or a bus. Note that each section in the vehicle control system 100 is directly connected to each other without intervention of the communication network 121, in some cases.

Note that, hereinafter, in a case where each section in the vehicle control system 100 performs communication through the communication network 121, description of the communication network 121 will be omitted. For example, in a case where the input section 101 communicates with the automatic driving controller 112 through the communication network 121, it is merely described that the input section 101 communicates with the automatic driving controller 112.

The input section 101 includes apparatuses used by a passenger to input, for example, various pieces of data and instructions. For example, the input section 101 includes an operation device such as a touch panel, a button, a microphone, a switch, and a lever, and an operation device capable of inputting various pieces of data and instructions by a method besides a manual operation using, for example, voice or gesture. Furthermore, for example, the input section 101 may be a remote control apparatus using an infrared ray or other radio waves, or an external connection apparatus corresponding to the operation of the vehicle control system 100, such as a mobile apparatus or a wearable apparatus. The input section 101 generates an input signal based on, for example, data or instructions input by the passenger, and supplies the input signal to the sections in the vehicle control system 100.

The data acquisition section 102 includes, for example, various kinds of sensors for acquiring data used in processes of the vehicle control system 100, and supplies the acquired data to the sections in the vehicle control system 100.

For example, the data acquisition section 102 includes various kinds of sensors for detecting, for example, states of the vehicle 10. Specifically, for example, the data acquisition section 102 includes a gyrosensor, an acceleration sensor, an inertial measurement unit (IMU), and sensors for detecting, for example, an operation amount of an accelerator pedal, an operation amount of a brake pedal, a steering angle of a steering wheel, an engine speed, a motor speed, or a rotation speed of a wheel.

In addition, for example, the data acquisition section 102 includes various kinds of sensors for detecting information of an outside of the vehicle 10. Specifically, for example, the data acquisition section 102 includes imaging apparatuses such as a ToF (Time Of Flight) camera, a stereo camera, a monocular camera, an infrared camera, and other cameras. Further, for example, the data acquisition section 102 includes an environment sensor for detecting, for example, weather or meteorological phenomena, and a surrounding information detection sensor for detecting an object around the vehicle 10. The environment sensor includes, for example, a raindrop sensor, a fog sensor, a sunlight sensor, and a snow sensor. The surrounding information detection sensor includes, for example, an ultrasonic sensor, a radar, LiDAR (Light Detection and Ranging, Laser Imaging Detection and Ranging), and a sonar.

In addition, for example, the data acquisition section 102 includes various kinds of sensors for detecting a current position of the vehicle 10. Specifically, the data acquisition section 102 includes, for example, a GNSS (Global Navigation Satellite System) receiver that receives a satellite signal from a GNSS satellite that is a navigation satellite (hereinafter, referred to as a GNSS signal).

In addition, for example, the data acquisition section 102 includes various kinds of sensors for detecting in-vehicle information. Specifically, the data acquisition section 102 includes, for example, an imaging apparatus that images a driver, a biosensor that detects bio-information of the driver, and a microphone that collects sound in a cabin. The biosensor is provided at, for example, a seat surface or a steering wheel, and detects bio-information of the passenger who sits on a seat or the driver who grips the steering wheel.

The communication section 103 communicates with, for example, the in-vehicle apparatus 104 and various apparatuses outside the vehicle, such as a server or a base station, to transmit data supplied from the sections in the vehicle control system 100 or to supply received data to the sections in the vehicle control system 100. Note that a communication protocol in which the communication section 103 supports is not particularly limited, and the communication section 103 can also support a plurality of kinds of communication protocols.

The communication section 103 wirelessly communicates with the in-vehicle apparatus 104 through, for example, wireless LAN, Bluetooth (registered trademark), NFC (Near Field Communication), or WUSB (Wireless USB). Further, the communication section 103 wiredly communicates with the in-vehicle apparatus 104 through, for example, USB (Universal Serial Bus), HDMI (registered trademark) (High-Definition Multimedia Interface), or MHL (Mobile High-definition Link), via a not-illustrated connection terminal (and a cable, if necessary).

In addition, for example, the communication section 103 communicates with an apparatus (e.g., an application server or a control server) present on an external network (e.g., the Internet, a cloud network, or a company-specific network) via a base station or an access point. Further, for example, the communication section 103 communicates with a terminal present near the vehicle 10 (e.g., a terminal of a pedestrian or a store, or MTC (Machine Type Communication) terminal) using P2P (Peer To Peer) technology. Further, for example, the communication section 103 performs V2X communication such as Vehicle to Vehicle communication, Vehicle to Infrastructure communication, Vehicle to Home communication, and Vehicle to Pedestrian communication. Further, for example, the communication section 103 includes a beacon receiver to receive radio waves or electromagnetic waves transmitted by, for example, a radio station installed on a road and acquires information such as a current position, traffic congestion, traffic regulation, or necessary time.

The in-vehicle apparatus 104 includes, for example, a mobile apparatus or a wearable apparatus owned by the passenger, an information apparatus carried into or attached to the vehicle 10, and a navigation apparatus that searches for a route to any destination.

The output controller 105 controls various kinds of outputs of information to the passenger of the vehicle 10 or the outside of the vehicle 10. For example, the output controller 105 generates an output signal including at least one of visual information (e.g., image data) or auditory information (e.g., sound data) and supplies the output signal to the output section 106, to control an output of the visual information and the auditory information from the output section 106. Specifically, for example, the output controller 105 synthesizes image data captured by different imaging apparatuses in the data acquisition section 102, generates, for example, an overhead image or a panorama image, and supplies an output signal including the generated image to the output section 106. Further, for example, the output controller 105 generates sound data including, for example, a warning sound or a warning message with respect to danger such as collision, contact, or entry to a dangerous zone, and supplies an output signal including the generated sound data to the output section 106.

The output section 106 includes an apparatus that can output the visual information or the auditory information to the passenger of the vehicle 10 or the outside of the vehicle 10. For example, the output section 106 includes a display apparatus, an instrument panel, an audio speaker, headphones, a wearable device such as a glass-type display that is worn by the passenger, a projector, and a lamp. The display apparatus included in the output section 106 may be an apparatus that displays the visual information in a visual field of the driver, such as a head-up display, a transmission type display, and an apparatus having an AR (Augmented Reality) display function, other than an apparatus having a normal display.

The driving-related controller 107 generates various kinds of control signals and supplies the control signals to the driving-related system 108 to control the driving-related system 108. Further, the driving-related controller 107 supplies the control signals to sections other than the driving-related system 108 to give a notice of, for example, a control state of the driving-related system 108, as necessary.

The driving-related system 108 includes various kinds of apparatuses regarding a driving system of the vehicle 10. For example, the driving-related system 108 includes a driving force generation apparatus for generating driving force, such as an internal combustion engine or a driving motor, a driving force transmission mechanism for transmitting the driving force to a wheel, a steering mechanism that adjusts a steering angle, a braking apparatus that generates braking force, ABS (Antilock Brake System), ESC (Electronic Stability Control), and an electric power steering apparatus.

The body-related controller 109 generates various kinds of control signals and supplies the control signals to the body-related system 110 to control the body-related system 110. Further, the body-related controller 109 supplies the control signals to sections other than the body-related system 110 to give a notice of, for example, a control state of the body-related system 110, as necessary.

The body-related system 110 includes various kinds of body-related apparatuses mounted on a body. For example, the body-related system 110 includes a keyless entry system, a smart key system, a power window apparatus, a power seat, a steering wheel, an air conditioner, and various kinds of lamps (e.g., a head lamp, a back lamp, a brake lamp, a blinker, and a fog lamp).

The storage 111 includes, for example, a ROM (Read Only Memory), a RAM (Random Access Memory), a magnetic storage device such as an HDD (Hard Disc Drive), a semiconductor storage device, an optical storage device, and a magneto-optical storage device. The storage 111 stores, for example, various kinds of programs and data to be used by the sections in the vehicle control system 100. For example, the storage 111 stores map data such as a three-dimensional accurate map including a dynamic map, a global map whose accuracy is lower than that of the accurate map and that covers a wider area, and a local map including information around the vehicle 10.

The automatic driving controller 112 controls automatic driving such as autonomous driving or driving assist. Specifically, for example, the automatic driving controller 112 performs cooperative control for implementing functions of ADAS (Advanced Driver Assistance System) including collision avoidance or shock absorption of the vehicle 10, following travel based on an inter-vehicle distance, vehicle speed holding travel, collision warning of the vehicle 10, and lane departure warning of the vehicle 10. Further, for example, the automatic driving controller 112 performs cooperative control aiming at automatic driving for autonomous travel without a driver's operation. The automatic driving controller 112 includes a detector 131, a self-position estimating section 132, a state analysis section 133, a planning section 134, and an operation controller 135.

The detector 131 detects various pieces of information necessary for controlling the automatic driving. The detector 131 includes an outer-vehicle information detector 141, an in-vehicle information detector 142, and a vehicle state detector 143.

The outer-vehicle information detector 141 performs a detection process of information of the outside of the vehicle 10 based on data or signals from the sections in the vehicle control system 100. For example, the outer-vehicle information detector 141 performs a detection process, a recognition process, and a tracking process with respect to an object around the vehicle 10, and a detection process of a distance up to the object. The object to be detected includes, for example, a vehicle, a human, an obstacle, a structure, a road, a traffic light, a traffic sign, and a traffic mark. Further, for example, the outer-vehicle information detector 141 performs a detection process of environment around the vehicle 10. The environment around the vehicle 10 to be detected includes, for example, weather, an air temperature, humidity, brightness, and a state of a road. The outer-vehicle information detector 141 supplies data indicating results of the detection processes to the self-position estimating section 132, a map analysis section 151, a traffic rule recognition section 152, and a state recognition section 153 in the state analysis section 133, and an emergency avoidance section 171 in the operation controller 135.

The in-vehicle information detector 142 performs a detection process of information of the inside of the vehicle 10 based on data or signals from the sections in the vehicle control system 100. For example, the in-vehicle information detector 142 performs an authentication process and a recognition process of the driver, a detection process of a state of the driver, a detection process of the passenger, and a detection process of environment inside the vehicle 10. The state of the driver to be detected includes, for example, a physical condition, vigilance, concentration, fatigue, and a gaze direction. The environment inside the vehicle 10 to be detected includes, for example, an air temperature, humidity, brightness, and smell. The in-vehicle information detector 142 supplies data indicating results of the detection processes to, for example, the state recognition section 153 in the state analysis section 133 and the emergency avoidance section 171 in the operation controller 135.

The vehicle state detector 143 performs a detection process of the state of the vehicle 10 based on data or signals from the sections in the vehicle control system 100. The state of the vehicle 10 to be detected includes, for example, speed, acceleration, a steering angle, presence and details of abnormality, a state of a driving operation, a position and inclination of a power seat, a state of a door lock, and states of other on-vehicle apparatuses. The vehicle state detector 143 supplies data indicating results of the detection processes to, for example, the state recognition section 153 in the state analysis section 133 and the emergency avoidance section 171 in the operation controller 135.

The self-position estimating section 132 performs an estimating process of, for example, a position and posture of the vehicle 10 based on data or signals from the sections in the vehicle control system 100, such as the outer-vehicle information detector 141, and the state recognition section 153 in the state analysis section 133. Further, the self-position estimating section 132 generates the local map used for estimating a self-position (hereinafter, referred to as a self-position estimation map) as necessary. The self-position estimation map serves as a highly accurate map using, for example, a technology such as SLAM (Simultaneous Localization and Mapping). The self-position estimating section 132 supplies data indicating results of the estimating process to the map analysis section 151, the traffic rule recognition section 152, and the state recognition section 153 in the state analysis section 133, for example. Further, the self-position estimating section 132 stores the self-position estimation map in the storage 111.

The state analysis section 133 performs an analyzing process of states of the vehicle 10 and periphery. The state analysis section 133 includes the map analysis section 151, the traffic rule recognition section 152, the state recognition section 153, and a state prediction section 154.

The map analysis section 151 performs an analyzing process of various types of maps stored in the storage 111 using data or signals from the sections in the vehicle control system 100, such as the self-position estimating section 132 and the outer-vehicle information detector 141, as necessary, to build a map including information necessary for an automatic driving process. The map analysis section 151 supplies the built map to the traffic rule recognition section 152, the state recognition section 153, and the state prediction section 154, as well as a route planning section 161, an action planning section 162, and an operation planning section 163 in the planning section 134, for example.

The traffic rule recognition section 152 performs a recognition process of a traffic rule around the vehicle 10 based on data or signals from the sections in the vehicle control system 100, such as the self-position estimating section 132, the outer-vehicle information detector 141, and the map analysis section 151. This recognition process enables recognition of a position and a state of a traffic light around the vehicle 10, details of traffic regulation around the vehicle 10, and a drivable traffic lane, for example. The traffic rule recognition section 152 supplies data indicating results of the recognition process to the state prediction section 154, for example.

The state recognition section 153 performs a recognition process of the state of the vehicle 10 based on data or signals from the sections in the vehicle control system 100, such as the self-position estimating section 132, the outer-vehicle information detector 141, the in-vehicle information detector 142, the vehicle state detector 143, and the map analysis section 151. For example, the state recognition section 153 performs recognition processes of the state of the vehicle 10, a state around the vehicle 10, and a state of the driver of the vehicle 10. Further, the state recognition section 153 generates the local map used for recognition of the state around the vehicle 10 (hereinafter, referred to as a state recognition map) as necessary. The state recognition map serves as an occupancy grid map, for example.

The state of the vehicle 10 to be recognized includes, for example, a position, posture, and movement (e.g., speed, acceleration, and a moving direction) of the vehicle 10, and presence and details of abnormality. The state around the vehicle 10 to be recognized includes, for example, a kind and a position of a stationary object therearound, a kind, a position, and movement (e.g., speed, acceleration, and a moving direction) of a moving object therearound, a configuration of a road and a state of a road surface therearound, and weather, an air temperature, humidity, and brightness therearound. The state of the driver to be recognized includes, for example, a physical condition, vigilance, concentration, fatigue, movement of a visual line, and driving operation.

The state recognition section 153 supplies data indicating results of the recognition processes (including the state recognition map, as necessary) to the self-position estimating section 132 and the state prediction section 154, for example. Further, the state recognition section 153 causes the state recognition map to be stored in the storage 111.

The state prediction section 154 performs a prediction process of the state of the vehicle 10 based on data or signals from the sections in the vehicle control system 100, such as the map analysis section 151, the traffic rule recognition section 152, and the state recognition section 153. For example, the state prediction section 154 performs prediction processes of the state of the vehicle 10, the state around the vehicle 10, and the state of the driver.

The state of the vehicle 10 to be predicted includes, for example, behavior of the vehicle 10, occurrence of abnormality, and a travelable distance. The state around the vehicle 10 to be predicted includes, for example, behavior of a moving object around the vehicle 10, change of a state of a traffic light, and change of environment such as weather. The state of the driver to be predicted includes, for example, behavior and a physical condition of the driver.

The state prediction section 154 supplies data indicating results of the prediction processes to, for example, the route planning section 161, the action planning section 162, and the operation planning section 163 in the planning section 134, together with data from the traffic rule recognition section 152 and the state recognition section 153.

The route planning section 161 plans a route to a destination based on data or signals from the sections in the vehicle control system 100, such as the map analysis section 151 and the state prediction section 154. For example, the route planning section 161 sets the route from a current position to a specified destination based on the global map. Further, for example, the route planning section 161 modifies the route as appropriate based on states such as congestion, an accident, traffic regulation, and construction, and the physical condition of the driver. The route planning section 161 supplies data indicating the planned route to the action planning section 162, for example.

The action planning section 162 plans an action of the vehicle 10 for safely traveling the route planned by the route planning section 161 within a planned time, based on data or signals from the sections in the vehicle control system 100, such as the map analysis section 151 and the state prediction section 154. For example, the action planning section 162 plans start, stop, a traveling direction (e.g., moving forward, moving backward, left turn, right turn, and traveling-direction change), a traveling lane, a traveling speed, and passing a vehicle traveling ahead. The action planning section 162 supplies data indicating the planned action of the vehicle 10 to, for example, the operation planning section 163.

The operation planning section 163 plans an operation of the vehicle 10 for achieving the action planned by the action planning section 162 based on data or signals from the sections in the vehicle control system 100, such as the map analysis section 151 and the state prediction section 154. For example, the operation planning section 163 plans acceleration, deceleration, and a traveling trajectory. The operation planning section 163 supplies data indicating the planned operation of the vehicle 10 to, for example, an acceleration/deceleration controller 172 and a direction controller 173 in the operation controller 135.

The operation controller 135 controls the operation of the vehicle 10. The operation controller 135 includes the emergency avoidance section 171, the acceleration/deceleration controller 172, and the direction controller 173.

The emergency avoidance section 171 performs a detection process of emergency such as collision, contact, entry to a dangerous zone, abnormality of the driver, and abnormality of the vehicle 10, based on the detection results of the outer-vehicle information detector 141, the in-vehicle information detector 142, and the vehicle state detector 143. When detecting occurrence of the emergency, the emergency avoidance section 171 plans the operation of the vehicle 10 for avoiding the emergency, such as sudden stop and steep turn. The emergency avoidance section 171 supplies data indicating the planned operation of the vehicle 10 to, for example, the acceleration/deceleration controller 172 and the direction controller 173.

The acceleration/deceleration controller 172 controls acceleration and deceleration for achieving the operation of the vehicle 10 planned by the operation planning section 163 or the emergency avoidance section 171. For example, the acceleration/deceleration controller 172 calculates a control target value of the driving force generation apparatus or the braking apparatus for achieving the planned acceleration, the planned deceleration, or the planned sudden stop, and supplies a control command indicating the calculated control target value to the driving-related controller 107.

The direction controller 173 performs direction control for achieving the operation of the vehicle 10 planned by the operation planning section 163 or the emergency avoidance section 171. For example, the direction controller 173 calculates a control target value of the steering mechanism for achieving the traveling trajectory or the steep turn planned by the operation planning section 163 or the emergency avoidance section 171, and supplies a control command indicating the calculated control target value to the driving-related controller 107.

### 2. Exemplary Embodiment

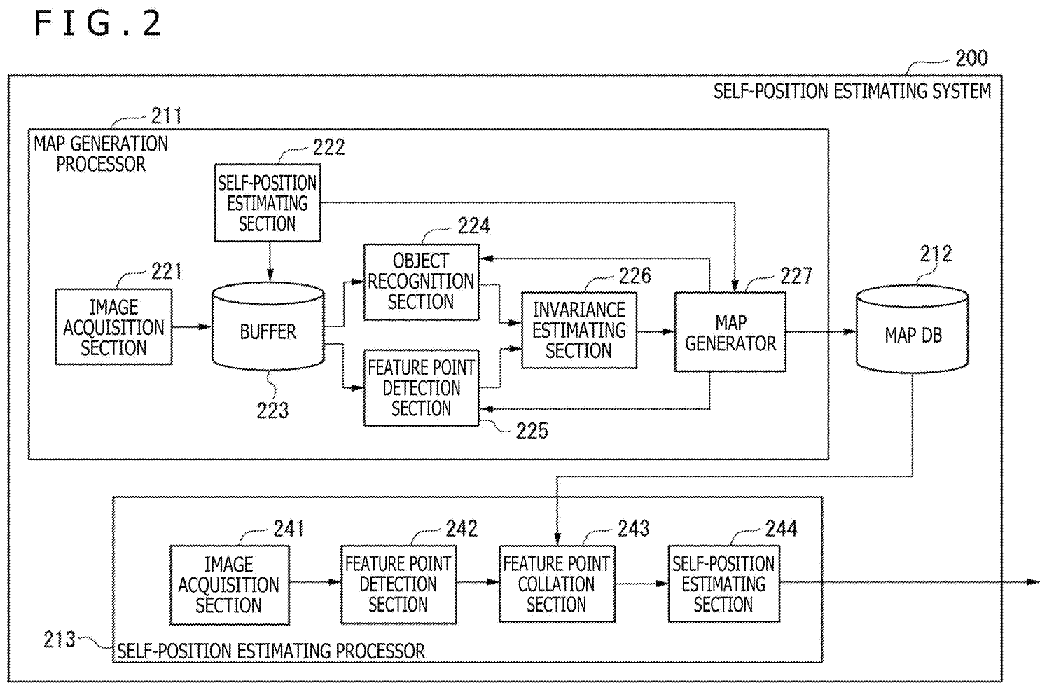

Subsequently, an exemplary embodiment of the present technology will be described with reference to FIGS. 2 to 11.

Note that this exemplary embodiment includes technologies mainly relating to the processes of the self-position estimating section 132, the outer-vehicle information detector 141, and the state recognition section 153 in the vehicle control system 100 in FIG. 1, and a generation process of a map used in the self-position estimating process.

### <Configuration Example of Self-Position Estimating System>

FIG. 2 is a block diagram illustrating a configuration example of a self-position estimating system 201 that is one exemplary embodiment of a self-position estimating system applied with the present technology.

The self-position estimating system 201 is a system that performs self-position estimation of the vehicle 10.

The self-position estimating system 201 includes a map generation processor 211, a map DB (database) 212, and a self-position estimating processor 213.

The map generation processor 211 performs a generation process of a key frame configuring a key frame map that is a map for estimating the self-position of the vehicle 10.

Note that the map generation processor 211 is not necessarily installed in the vehicle 10. For example, the map generation processor 211 may be installed in a vehicle different from the vehicle 10, and the vehicle different from the vehicle 10 may be used to generate the key frame.

Note that, hereinafter, an example of a case where the map generation processor 211 is installed in the vehicle different from the vehicle 10 (hereinafter, referred to as a map generation vehicle) will be described.

The map generation processor 211 includes an image acquisition section 221, a self-position estimating section 222, a buffer 223, an object recognition section 224, a feature point detector 225, an invariance estimating section 226, and a map generator 227.

The image acquisition section 221 includes, for example, a camera, captures an image ahead of the map generation vehicle, and stores the acquired image (hereinafter, referred to as a reference image) in the buffer 223.

The self-position estimating section 222 performs a self-position estimating process of the map generation vehicle, supplies data indicating the estimation result to the map generator 227, and stores the data in the buffer 223.

The object recognition section 224 performs a recognition process of an object in the reference image, and supplies data indicating the recognition result to the invariance estimating section 226.

The feature point detector 225 performs a detection process of feature points in the reference image, and supplies data indicating the detection result to the invariance estimating section 226.

The invariance estimating section 226 performs an invariance estimating process of the feature points in the reference image, and supplies data indicating the estimated result and the reference image to the map generator 227.

The map generator 227 generates the key frame, and registers the key frame in the map DB 212. The key frame includes, for example, data indicating a position in an image coordinate system and a feature amount of each feature point detected in the reference image and a position and posture of the map generation vehicle in a world coordinate system when the reference image is captured (i.e., a position and posture at which the reference image is captured).

Note that, hereinafter, the position and posture of the map generation vehicle when the reference image used for the key frame generation is captured are also referred merely to as a position and posture of the key frame.

In addition, the map generator 227 instructs the object recognition section 224 to perform the recognition process of the object in the reference image, or instructs the feature point detector 225 to perform the detection process of the feature points in the reference image.

The map DB 212 stores a key frame map including a plurality of key frames based on a plurality of reference images captured by the map generation vehicle traveling at various locations.

Note that the number of the map generation vehicles used for the key frame map generation may not be necessarily one, and may be two or more.

Furthermore, the map DB 212 is not necessarily installed in the vehicle 10, and may be installed in a server, for example. In this case, for example, the vehicle 10 refers to or downloads the key frame map stored in the map DB 212 before traveling or during traveling. The key frame map thus downloaded is temporarily stored in the storage 111 (FIG. 1) in the vehicle 10, for example.

The self-position estimating processor 213 is installed in the vehicle 10, and performs the self-position estimating process of the vehicle 10. The self-position estimating processor 213 includes an image acquisition section 241, a feature point detector 242, a feature point collation section 243, and a self-position estimating section 244.

The image acquisition section 241 includes, for example, a camera, captures an image ahead of the vehicle 10, and supplies the acquired image (hereinafter, referred to as an observed image) to the feature point detector 242.

The feature point detector 242 performs a detection process of feature points in the observed image, and supplies data indicating the detection result to the feature point collation section 243.

The feature point collation section 243 performs a collation process between the feature points in the observed image and the feature points in the key frames of the key frame map stored in the map DB 212. The feature point collation section 243 supplies the collation result regarding the feature points and data indicating a position and posture of each of the key frames used for the collation to the self-position estimating section 244.

The self-position estimating section 244 estimates a position and posture of the vehicle 10 in the world coordinate system, based on the collation result between the feature points in the observed image and the feature points in the key frame, and the position and posture of the key frame used for the collation. The self-position estimating section 244 supplies data indicating the position and posture of the vehicle 10 to, for example, the map analysis section 151, the traffic rule recognition section 152, and the state recognition section 153 in FIG. 1.

Note that, in a case where the map generation processor 211 is installed in the vehicle 10, not in the map generation vehicle, in other words, in a case where the vehicle used for generation of the key frame map and the vehicle for performing the self-position estimating process are identical, the image acquisition section 221 and the feature point detector 225 in the map generation processor 211 and the image acquisition section 241 and the feature point detector 242 in the self-position estimating processor 231 can be made common, for example.

### <Map Generation Process>

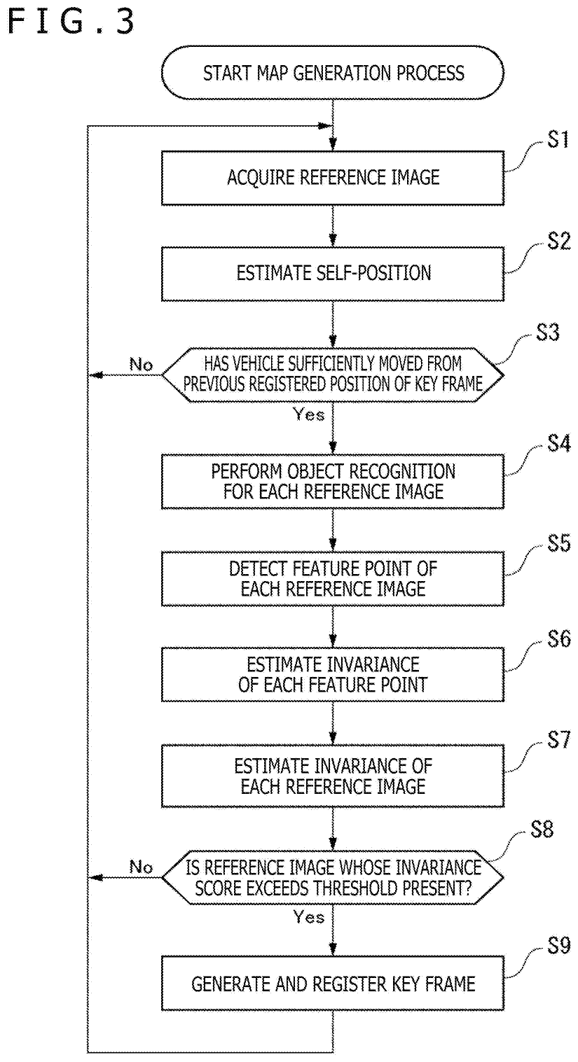

Subsequently, with reference to a flowchart in FIG. 3, the map generation process to be performed by the map generation processor 211 will be described. Note that this process starts, for example, when the map generation vehicle is started and an operation for starting driving is performed, for example, when an ignition switch, a power switch, or a start switch in the map generation vehicle is turned on. This process ends, for example, when an operation for ending driving is performed, for example, when the ignition switch, the power switch, or the start switch in the map generation vehicle is turned off.

In step S1, the image acquisition section 221 acquires the reference image. Specifically, the image acquisition section 221 captures an image ahead of the map generation vehicle, and stores the acquired reference image in the buffer 223.

In step S2, the self-position estimating section 222 estimates a self-position. In other words, the self-position estimating section 222 estimates the position and posture of the map generation vehicle in the world coordinate system. With this configuration, the position and posture of the map generation vehicle when the reference image is captured with the process in step S1 are estimated. The self-position estimating section 222 supplies data indicating the estimation result to the map generator 227, and gives the data indicating the estimation result to the reference image stored in the buffer 223 as metadata.

Note that any method can be used for the self-position estimating method of the map generation vehicle. For example, a highly accurate estimating method using RTK (Real Time Kinematic)-GNSS or LiDAR is used.

In step S3, the map generator 227 determines whether or not the map generation vehicle has sufficiently moved from a registered position of the previous key frame. Specifically, the map generator 227 calculates a distance between the position of the map generation vehicle when the reference image used for previous key frame generation is acquired and the position of the map generation vehicle estimated by the process in step S2. In a case where the calculated distance is less than a predetermined threshold, the map generator 227 determines that the map generation vehicle has not yet sufficiently moved from the registered position of the previous key frame, and the process returns to step S1.

Subsequently, until it is determined that the map generation vehicle has sufficiently moved from the registered position of the previous key frame in step S3, the processes from step S1 to step S3 are repeatedly executed.

On the other hand, in step S3, in a case where the calculated distance is more than or equal to the predetermined threshold, the map generator 227 determines that the map generation vehicle has sufficiently moved from the registered position of the previous key frame, and the process proceeds to step S4.

Note that, before a first key frame is registered, the process in step S3 is skipped, and the process unconditionally proceeds to step S4, for example.

In step S4, the object recognition section 224 performs object recognition for each reference image. Specifically, the map generator 227 instructs the object recognition section 224 to perform the recognition process of the object in the reference image.

The object recognition section 224 reads, from the buffer 223, all reference images stored in the buffer 223. Note that, in the buffer 223, the reference image acquired after previous performance of processes from step S4 to step S5 is stored. However, in a case where the processes from step S4 to step S5 are performed at first time, the reference image acquired after the map generation process is started is stored in the buffer 223.

The object recognition section 224 performs the recognition process of the object in each reference image. With this process, for example, a position and a kind of the object in each reference image are recognized.

Note that any method such as semantic segmentation can be used for the recognition method of the object in the reference image.

The object recognition section 224 supplies data indicating the recognition result of the object in each reference image to the invariance estimating section 226.

In step S5, the feature point detector 225 detects feature points in each reference image. Specifically, the map generator 227 instructs the feature point detector 225 to perform a feature point detection process in the reference image.

The feature point detector 225 reads, from the buffer 223, all reference images stored in the buffer 223. The feature point detector 225 performs the feature point detection process in each reference image. With this process, for example, a position and a feature amount of each of the feature points in each reference image are detected.

Note that, as the feature point detection method, any method such as a Harris corner can be used.

The feature point detector 225 supplies data indicating the detection result of the feature points in each reference image and the reference image to the invariance estimating section 226. Further, the feature point detector 225 deletes the read reference images from the buffer 223.

In step S6, the invariance estimating section 226 estimates invariance of each feature point. Specifically, the invariance estimating section 226 acquires an invariance score of each feature point based on a kind of an object to which each feature point in each reference image belongs.

Herein, the invariance score is a score indicating a degree in which the feature point is less likely to change against lapse of time or change of environment. More specifically, the invariance score is a score indicating a degree in which a position and a feature amount of the feature point are less like to change against lapse of time or change of environment. Accordingly, an invariance score of a feature point in which change of a position and a feature amount is smaller against lapse of time or change of environment turns higher. For example, since a position of a feature point of a stationary object does not substantially change, its feature point score turns high. On the other hand, an invariance score of a feature point in which change of at least one of a position or a feature amount is larger against at least one of lapse of time or change of environment turns lower. For example, since a position of a feature point of a moving object easily changes, its feature point score turns low.

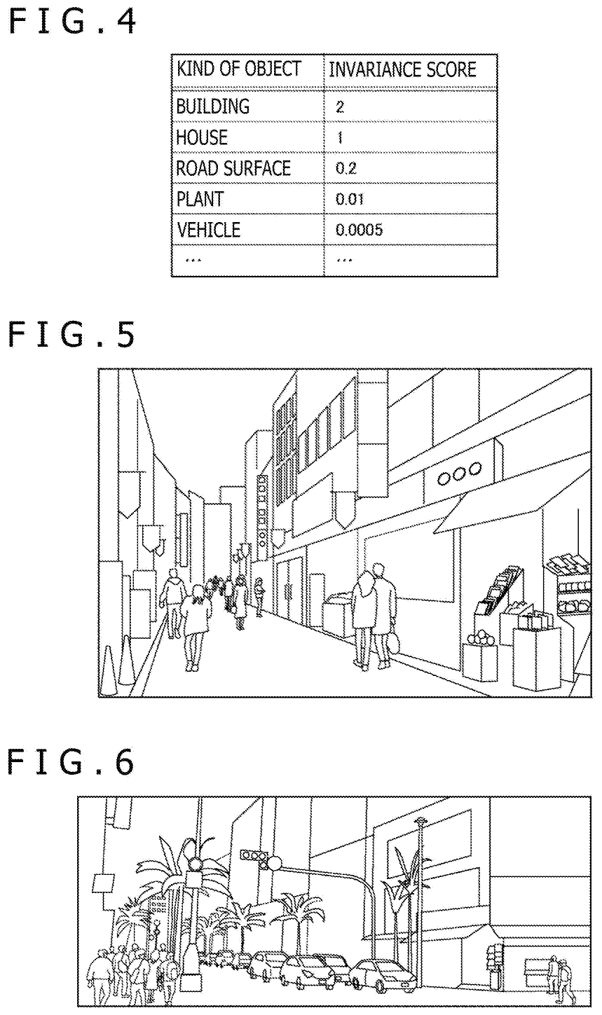

FIG. 4 illustrates examples of the invariance scores. In the examples, objects are categorized into a plurality of kinds, and the invariance score is individually set for each object.

For example, a building and a house are stationary objects whose positions do not change. Furthermore, construction or destroy of those objects is less likely to be performed. Therefore, a position and a feature amount of a feature point detected in the building or the house are less likely to change. Accordingly, the invariance scores of the building and the house are set high.

Note that an appearance of the house is more likely to change than that of the building, due to, for example, rearranging or hanging washing out to dry. Accordingly, the invariance score of the house is set lower than that of the building.

Note that, for example, as illustrated in FIG. 5 and FIG. 6, in commercial facilities such as stores located on the same level as a road surface, signboards, displays, or exhibition layouts of merchandise is frequently changed, for example. In addition, for example, merchandise carrying trucks, or vehicles or bicycles of customers are often parked in front of the commercial facilities. Furthermore, there are many cases such as opening and closing of shutters of stores, replacement of stores, and closing of stores. Accordingly, invariance scores of the commercial facilities (particularly, the commercial facilities located on the same level as the road surface) may be set low, even though the commercial facilities are buildings.

Although the road surface is a stationary object, its change against lapse of time or change of environment is relatively large. For example, a state of the road surface (e.g., reflection characteristic) largely changes, or a viewed state of a traffic mark, for example, a white line on the road surface largely changes, due to, for example, a wet road surface or a puddle caused by rain, or accumulated snow. As a result, a position and a feature amount of a feature point detected on the road surface largely change.

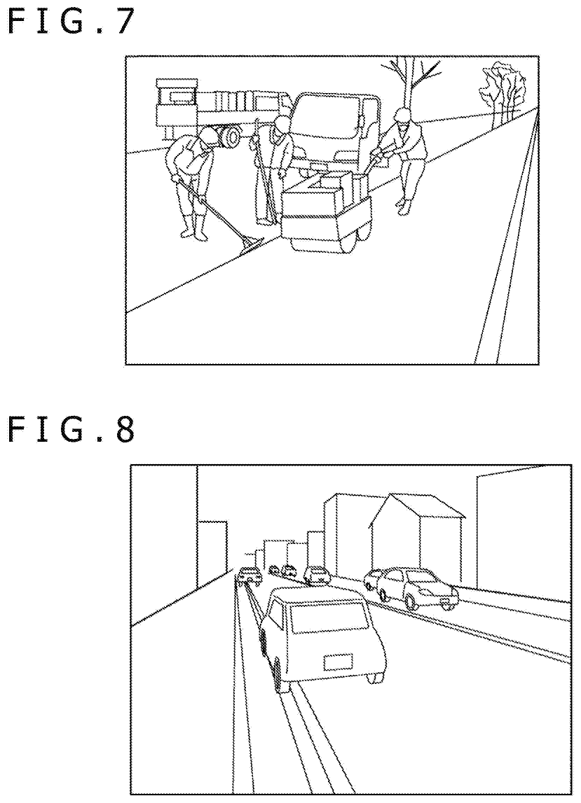

In addition, for example, as illustrated in FIG. 7, in the road, construction is often performed compared to the structure such as the building or the house. When the road construction is performed, trucks, machines, tools, or guide plates of the construction, for example, are placed on the road surface. Further, the traffic mark on the road surface is erased or revised, in some cases. As a result, the position and the feature amount of the feature point detected on the road surface largely change.

Furthermore, for example, as illustrated in FIG. 8, the traffic mark on the road surface is often hidden by a vehicle parked on the road. As a result, the position and the feature amount of the feature point detected on the road surface largely change.

Accordingly, an invariance score of the road surface is set lower than those of the building and the house.

Plants are stationary objects whose positions are not basically moved, but change thereof against lapse of time or change of environment is large. For example, colors and shapes of the plants change due to, for example, blooming flowers, thickly growing leaves, changing colors of leaves, falling leaves, growing leaves, or withering leaves, depending on seasons. Further, the shapes of the plants change while waving in the wind. As a result, a position and a feature amount of the feature point detected in the plant largely change. Accordingly, an invariance score of the plant is set lower than that of the road surface.

The vehicle is a moving body, and therefore is extremely likely to move from a current position to leave. Accordingly, an invariance score of the vehicle is set extremely low.

Note that FIG. 4 is an example of a setting method of the invariance score, and can be modified in any way. For example, it is possible to increase kinds of objects, or to categorize the objects more minutely.

In step S7, the invariance estimating section 226 estimates invariance of each reference image. Specifically, the invariance estimating section 226 totalizes the invariance score of each feature point for each reference image, and defines the totalized value as the invariance score of each reference image. Accordingly, an invariance score of a reference image including more feature points each of which has a higher invariance score turns higher.

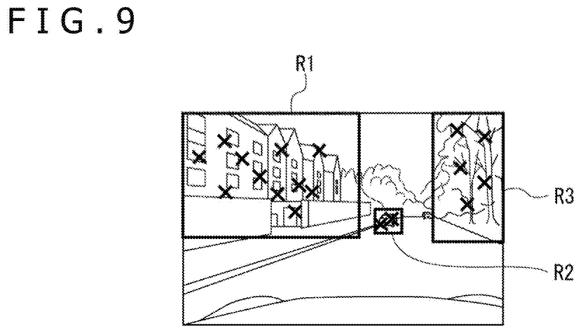

Herein, with reference to FIG. 9, a specific example of a calculation method of the invariance score of the reference image will be described. FIG. 9 illustrates an example of the reference image. X marks in the reference image indicate positions of detected feature points. In this reference image, the feature points are detected in a region R1 to a region R3. The region R1 is recognized as a house, the region R2 is recognized as a vehicle, and the region R3 is recognized as a plant.

In the case of this example, based on the table in FIG. 4, a value 1 that is the invariance score of the house is given to each feature point in the region R1. A value 0.0005 that is the invariance score of the vehicle is given to each feature point in the region R2. A value 0.01 that is the invariance score of the plant is given to each feature point in the region R3. By totalizing the invariance score given to each feature point, the invariance score of the reference image is calculated.

The invariance estimating section 226 supplies, to the map generator 227, data indicating the positions, the feature amounts, and the invariance scores of the feature points in each reference image, data indicating the invariance score of each reference image, and each reference image.

In step S8, the map generator 227 determines whether or not a reference image whose invariance score exceeds a threshold is present. In a case where the map generator 227 determines that the reference image whose invariance score exceeds the threshold is present, the process proceeds to step S9.

In step S9, the map generator 227 generates and registers the key frame.

For example, the map generator 227 selects a reference image whose invariance score is highest as a reference image used for generation of the key frame. Next, the map generator 227 extracts feature points whose invariance scores are more than or equal to a threshold from among the feature points of the selected reference image. The map generator 227 then generates a key frame including data indicating a position and a feature amount, in an image coordinate system, of each extracted feature point, and a position and posture, in the world coordinate system, of the map generation vehicle when the reference image is captured (i.e., an acquisition position and acquisition posture of the key frame). The map generator 227 registers the generated key frame in the map DB 212.

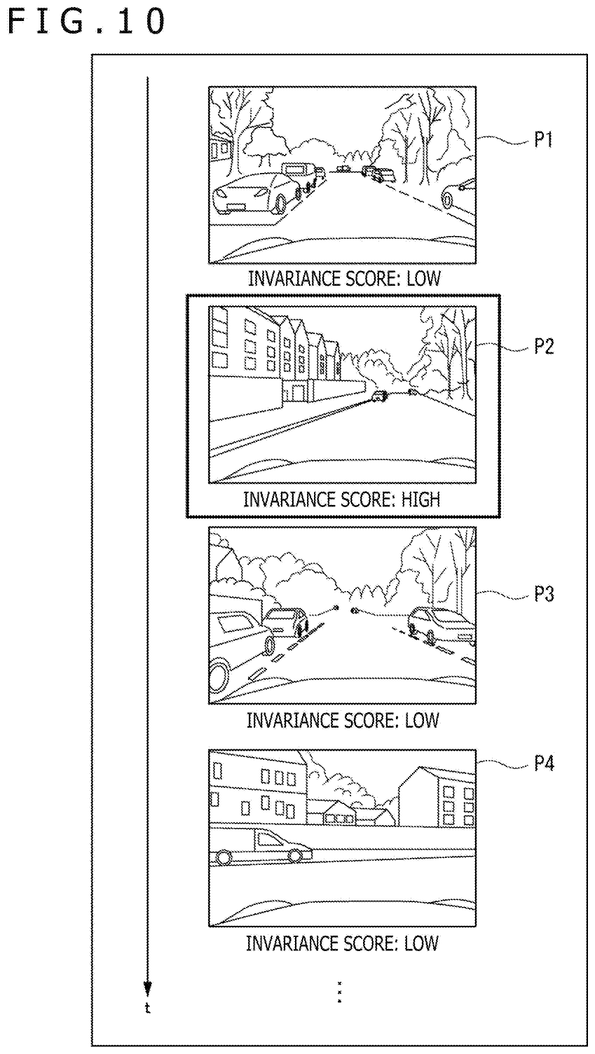

For example, as illustrated in FIG. 10, in a case where a reference image P1 to a reference image P4 are acquired, the key frame is generated based on the reference image P2 whose invariance score is highest and is registered.

The process then returns to step S1, and step S1 and the steps subsequent to step S1 are performed.

On the other hand, in step S8, in a case where the map generator 227 determines that the reference image whose invariance score exceeds the threshold is not present, the process in step S9 is not performed, the process returns to step S1, and step S1 and the steps subsequent to step S1 are performed. In other words, since the reference image including many feature points each of which has high invariance is not acquired, the key frame is not generated.

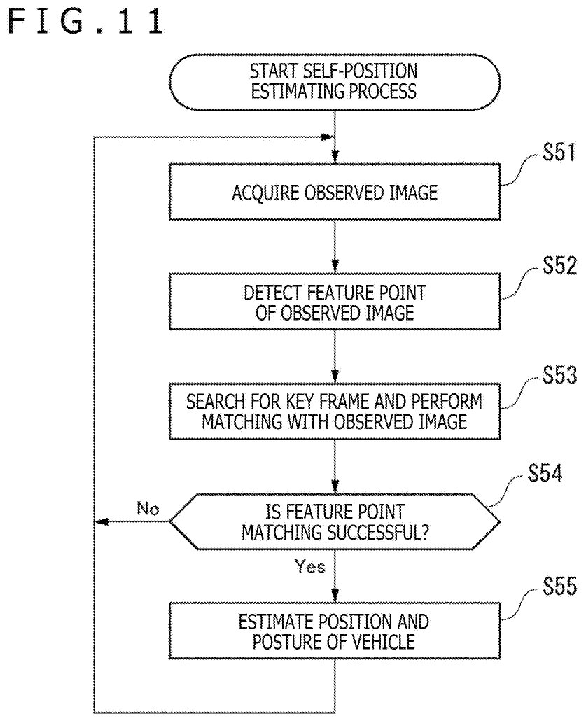

Subsequently, with reference to a flowchart in FIG. 11, a self-position estimating process to be performed by the self-position estimating processor 213 will be described. Note that, for example, this process starts when the vehicle 10 is started and an operation for starting driving is performed, for example, when the ignition switch, the power switch, or the start switch of the vehicle 10 is turned on. Further, this process ends when an operation for ending driving is performed, for example, when the ignition switch, the power switch, or the start switch of the vehicle 10 is turned off.

In step S51, the image acquisition section 241 acquires the observed image. Specifically, the image acquisition section 241 captures an image ahead of the vehicle 10, and supplies the acquired observed image to the feature point detector 242.

In step S52, the feature point detector 242 detects feature points in the observed image. The feature point detector 242 supplies data indicating the detection result to the feature point collation section 243.

Note that as the detection method of the feature points, a method similar to the feature point detector 225 in the map generation processor 211 is used.

In step S53, the feature point collation section 243 searches for the key frame, and performs matching with the observed image. For example, the feature point collation section 243 searches for a key frame whose acquisition position is close to a position of the vehicle 10 when the observed image is captured, from among the key frames stored in the map DB 212. Next, the feature point collation section 243 performs matching between the feature points in the observed image and feature points in the key frame acquired through the search (i.e., the feature points in the reference image captured in advance).

Note that, in a case where a plurality of key frames is extracted, the feature point matching is performed between each of the key frames and the observed image.

Next, in a case where a key frame that is successful in the feature point matching with the observed image is present, the feature point collation section 243 calculates a matching rate between the observed image and the key frame that is successful in the feature point matching. For example, the feature point collation section 243 calculates a ratio of feature points that are successful in matching with the feature points in the key frame among the feature points in the observed image, as the matching rate. Note that, in a case where a plurality of key frames that is successful in feature point matching is present, the matching rate is calculated for each key frame.

The feature point collation section 243 then selects a key frame whose matching rate is highest as a reference key frame. Note that, in a case where only one key frame is successful in the feature point matching, this key frame is selected as the reference key frame.

The feature point collation section 243 supplies matching information between the observed image and the reference key frame and data indicating an acquisition position and acquisition posture of the reference key frame to the self-position estimating section 244. Note that the matching information includes, for example, a position and a corresponding relation of each feature point that is successful in the matching between the observed image and the reference key frame.

In step S54, the feature point collation section 243 determines whether or not the feature point matching is successfully performed based on the result of the process in step S53. In a case where it is determined that the feature point matching is failed, the process returns to step S51.

After that, the processes from step S51 to step S54 are repeatedly performed until it is determined that the feature point matching is successfully performed in step S54.

On the other hand, in a case where it is determined that the feature point matching is successfully performed in step S54, the process proceeds to step S55.

In step S55, the self-position estimating section 244 estimates a position and posture of the vehicle 10. Specifically, the self-position estimating section 244 calculates the position and posture of the vehicle 10 for the acquisition position and the acquisition posture of the reference key frame based on the matching information between the observed image and the reference key frame, and the acquisition position and the acquisition posture of the reference key frame. More precisely, the self-position estimating section 244 calculates the position and the posture of the vehicle 10 for the position and the posture of the map generation vehicle when the reference image corresponding to the reference key frame is captured.

Next, the self-position estimating section 244 converts the position and posture of the vehicle 10 for the acquisition position and the acquisition posture of the reference key frame to a position and posture in the world coordinate system. The self-position estimating section 244 then supplies data indicating the estimated result of the position and the posture, in the world coordinate system, of the vehicle 10 to, for example, the map analysis section 151, the traffic rule recognition section 152, and the state recognition section 153 in FIG. 1.

After that, the process returns to step S51, and step S51 and the steps subsequent to step S51 are performed.

As described above, the key frame is generated based on the reference image having high invariance, and only feature points each having high invariance are registered in the key frame. Therefore, the matching rate between the feature points of the observed image and the feature points of the key frame (collation accuracy between the feature points of the observed image and the feature points of the key frame) is improved. As a result, accuracy of self-position estimation of the vehicle 10 is improved.

A key frame based on a reference image having low invariance is not generated. Therefore, a load for generation of a key frame map and a capacity of the key frame map can be reduced. Further, the feature points each having low invariance are not registered in the key frame. Therefore, the capacity of the key frame map can further be reduced.

### 3. Modifications

Hereinafter, modifications of the exemplary embodiment of the present technology described above will be described.

In the above description, with the process in step S9 in FIG. 3, an example in which only the reference image having highest invariance score is used to generate the key frame is illustrated. However, for example, all reference images each of which has an invariance score exceeding the threshold may be used to generate the key frames.

Alternatively, for example, each key frame may include invariance (e.g., invariance score) of each feature point.

In this case, for example, the feature point collation section 243 may perform collation between the feature points of the observed image and the feature points of the key frame while weighting based on the invariance of each feature point in the key frame. For example, in a case where the matching rate between the observed image and the key frame is calculated, the feature point collation section 243 may increase a matching score for a feature point having high invariance, and may decrease a matching score for a feature point having low invariance. With this procedure, a higher frequency in which the matching with the feature point having high invariance score is successful increases the matching rate more.

In the above description, an example in which the feature points each of which has the invariance score more than or equal to the threshold are extracted and registered in the key frame is illustrated. However, all feature points may be registered in the key frame together with their invariance scores. In this case, for example, the feature point collation section 243 may perform collation between the observed image and the key frame using only feature points each of which has the invariance score more than or equal to a predetermined threshold among the feature points in the key frame. Further, in this case, the threshold may be changed depending on conditions such as weather.

Furthermore, a plurality of cameras may be installed in the image acquisition section 221 in the map generation processor 211, and reference images may be captured by the plurality of cameras. In this case, all cameras do not necessarily capture the image ahead of the map generation vehicle, but some or all of the cameras may capture images in directions other than the direction ahead of the map generation vehicle.

Similarly, a plurality of cameras may be installed in the image acquisition section 241 in the self-position estimating processor 213, and observed images may be captured by the plurality of cameras. In this case, all cameras do not necessarily capture the image ahead of the vehicle 10, but some or all of the cameras may capture images in directions other than the direction ahead of the vehicle 10.

Furthermore, for example, a key frame having a low success rate of the matching with the observed image may be deleted. For example, a key frame whose success rate of the matching with the observed image has been less than a predetermined threshold during a predetermined period or a key frame that has not been successful in the matching with the observed image during a period more than or equal to a predetermined period may be deleted.

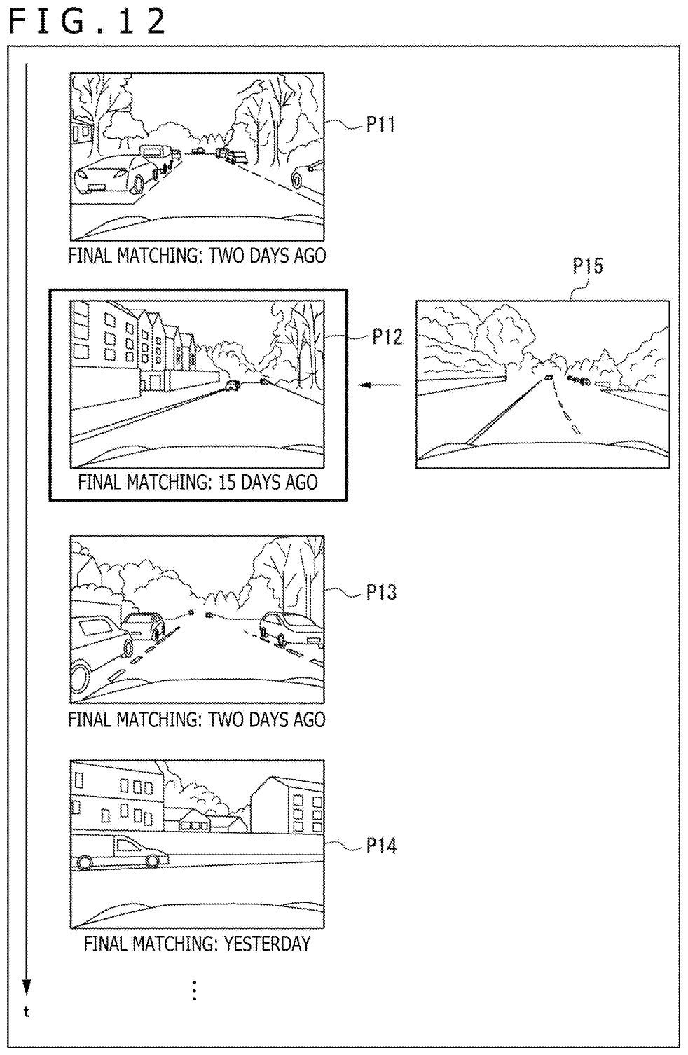

For example, FIG. 12 illustrates an example of a reference image P11 to a reference image P14 that serve as sources of registered key frames. For example, it is assumed that a key frame based on the reference image P11 was finally matched with the observed image successfully two days ago, a key frame based on the reference image P12 was finally matched with the observed image successfully 15 days ago, a key frame based on the reference image P13 was finally matched with the observed image successfully two days ago, and a key frame based on the reference image P14 was finally matched with the observed image successfully yesterday. For example, in a case where it is decided to delete a key frame that has not been successfully matched with the observed image for a period more than or equal to two weeks, the key frame based on the reference image P12 is deleted.

With this procedure, for example, an unnecessary key frame that is difficult to be matched with the observed image due to significant change of a state within an imaging range of the reference image P12 after the reference image P12 was captured can be deleted. With this procedure, the capacity of the map DB 212 can effectively be used.

Note that, in this case, for example, a key frame based on a reference image P15 that is newly captured at a position and posture close to those of the reference image P12 may newly be generated and registered.

Furthermore, the invariance score of the feature point may be set by adding conditions other than the kind of the object, for example, surrounding environment. For example, an invariance score of a feature point of a location where conditions that affect the feature amount (e.g., sunshine, lighting, and weather) largely change may be decreased.

Alternatively, for example, the invariance score of each feature point may be set based on a degree in which the feature points are less likely to change against one of lapse of time or change of environment, not against both of them.

Furthermore, the present technology is also applicable to a case where the self-position estimation is performed for various kinds of moving bodies such as a motorcycle, a bicycle, a personal mobility, an airplane, a ship, a construction machine, an agricultural machine (tractor), a drone, and a robot, other than the above-illustrated vehicle.

### 4. Others

### <Configuration Example of Computer>

A series of processes described above can be performed by hardware, or can be performed by software. In a case where the series of processes are performed by software, programs configuring the software are installed in a computer. Herein, examples of the computer include a computer incorporated in dedicated hardware, and a computer capable of performing various functions while being installed with various kinds of programs, for example, a general-purpose computer.

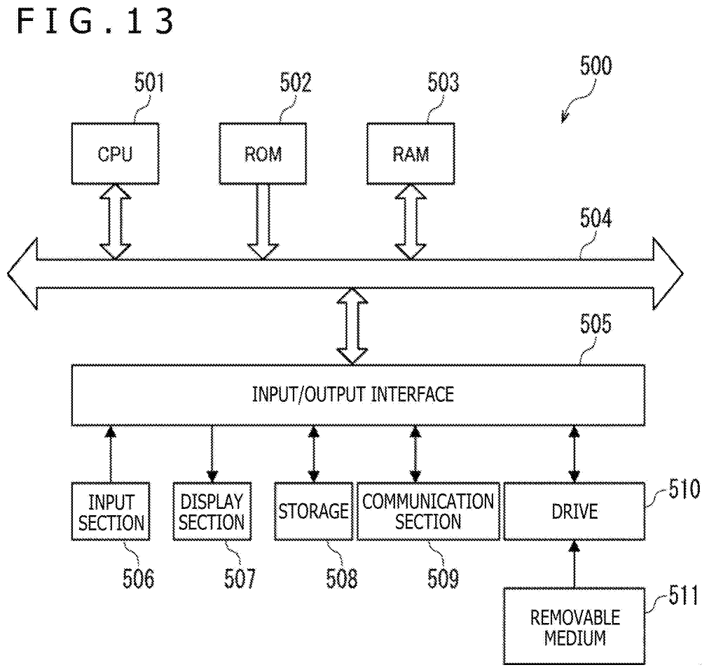

FIG. 13 is a block diagram illustrating a hardware configuration example of a computer that performs the series of processes described above by the programs.

In a computer 500, a CPU (Central Processing Unit) 501, a ROM (Read Only Memory) 502, and a RAM (Random Access Memory) 503 are mutually connected through a bus 504.

Further, an input/output interface 505 is connected to the bus 504. The input/output interface 505 is connected with an input section 506, an output section 507, a recording section 508, a communication section 509, and a drive 510.

The input section 506 includes, for example, an input switch, a button, a microphone, and an imaging element. The output section 507 includes, for example, a display and a speaker. The recording section 508 includes, for example, a hard disk and a nonvolatile memory. The communication section 509 includes, for example, a network interface. The drive 510 drives a removable recording medium 511 such as a magnetic disk, an optical disk, a magneto-optical disk, or a semiconductor memory.

In the computer 500 thus configured, for example, the CPU 501 loads programs recorded in the recording section 508 to the RAM 503 via the input/output interface 505 and the bus 504, and executes the programs, thereby performing the series of processes described above.

The programs to be executed by the computer 500 (CPU 501) can be provided while being recorded in the removable recording medium 511 as, for example, a package medium. Further, the programs can be provided via a wired or wireless transmission medium such as a local area network, the Internet, or digital satellite broadcasting.

In the computer 500, the programs can be installed in the recording section 508 via the input/output interface 505 by mounting the removable recording medium 511 on the drive 510. Further, the programs can be installed in the recording section 508 by receiving the programs with the communication section 509 via the wired or wireless transmission medium. Otherwise, the programs can be installed in the ROM 502 or the recording section 508 in advance.

Note that the programs to be executed by the computer may be programs in which the processes are performed in time series in order described in this specification, or may be programs in which the processes are performed in parallel or at required timing, for example, when a call is issued.

In this specification, a system means a set of a plurality of components (e.g., apparatuses and modules (parts)), regardless of whether all components are included in an identical housing or not. Accordingly, both a plurality of apparatuses that is housed in separate housings and is connected via a network, and one apparatus in which a plurality of modules is housed in one housing are referred to as the system.

Furthermore, the exemplary embodiment of the present technology is not limited to the above-described exemplary embodiment, and can variously be modified without departing from the gist of the present technology.

For example, the present technology can adopt a configuration of cloud computing in which a plurality of apparatuses takes charge and collaborates to process one function via a network.

Each step explained in the above-described flowcharts can be performed by one apparatus, or can be performed by a plurality of apparatuses while sharing.

Furthermore, in a case where one step includes a plurality of processes, the plurality of processes included in the one step can be performed by one apparatus, or can be performed by a plurality of apparatuses while sharing.

### <Combination Example of Configurations>

The present technology can also adopt the following configurations.

(1)

An information processing apparatus including:

a feature point detector that detects a feature point in a reference image used for self-position estimation of a moving body;

an invariance estimating section that estimates invariance of the feature point; and

a map generator that generates a map based on the feature point and the invariance of the feature point.

(2)

The information processing apparatus according to the item (1), in which the map generator extracts the reference image used for the map based on invariance of the reference image based on the invariance of the feature point.

(3)

The information processing apparatus according to the item (2), in which the map generator extracts the reference image used for the map based on an invariance score that is obtained by totalizing an invariance score indicating the invariance of the feature point for each reference image and indicates the invariance of the reference image.

(4)

The information processing apparatus according to any one of the items (1) to (3), in which the map generator extracts the feature point used for the map based on the invariance of the feature point.

(5)

The information processing apparatus according to any one of the items (1) to (4), further including:

an object recognition section that performs a recognition process of an object in the reference image, in which the invariance estimating section estimates the invariance of the feature point based on a kind of the object to which the feature point belongs.

(6)

The information processing apparatus according to any one of the items (1) to (5), in which the invariance of the feature point indicates a degree in which the feature point is less likely to change against at least one of lapse of time or change of environment.

(7)

The information processing apparatus according to any one of the items (1) to (6), in which the map includes a position, a feature amount, and the invariance of the feature point.

(8)

An information processing method including:

detecting a feature point in a reference image used for self-position estimation of a moving body;

estimating invariance of the feature point; and

generating a map based on the feature point and the invariance of the feature point.

(9)

A program for causing a computer to execute:

detecting a feature point in a reference image used for self-position estimation of a moving body;

estimating invariance of the feature point; and

generating a map based on the feature point and the invariance of the feature point.

(10)

A moving body including:

a feature point detector that detects a feature point in an observed image;

a feature point collation section that performs collation between a feature point in a map generated based on the feature point and invariance of the feature point and the feature point in the observed image; and

a self-position estimating section that performs self-position estimation based on a collation result between the feature point in the map and the feature point in the observed image.

(11)

The moving body according to the item (10), in which the feature point collation section performs the collation between the feature point in the map and the feature point in the observed image while weighting based on invariance of the feature point in the map.

(12)

The moving body according to the item (10) or (11), in which the feature point collation section performs the collation between a feature point whose invariance is more than or equal to a predetermined threshold among a plurality of the feature points in the map and the feature point in the observed image.

(13)

The moving body according to any one of the items (10) to (12), in which the invariance of the feature point indicates a degree in which the feature point is less likely to change against at least one of lapse of time or change of environment.

Note that effects described in this specification are merely illustrative and are not limited, and other effects may be achieved.

### REFERENCE SIGNS LIST

10 Vehicle
100 Vehicle control system
132 Self-position estimating section
141 Outer-vehicle information detector
201 Self-position estimating system
211 Map generation processor
213 Self-position estimating processor
221 Image acquisition section
224 Object recognition section
225 Feature point detector
226 Invariance estimating section
227 Map generator
241 Image acquisition section
242 Feature point detector
243 Feature point collation section
244 Self-position estimating section

1. An information processing apparatus comprising:
a feature point detector that detects a feature point in a reference image used for self-position estimation of a moving body;
an invariance estimating section that estimates invariance of the feature point; and
a map generator that generates a map based on the feature point and the invariance of the feature point.

2. The information processing apparatus according to claim 1, wherein the map generator extracts the reference image used for the map based on invariance of the reference image based on the invariance of the feature point.

3. The information processing apparatus according to claim 2, wherein the map generator extracts the reference image used for the map based on an invariance score that is obtained by totalizing an invariance score indicating the invariance of the feature point for each reference image and indicates the invariance of the reference image.

4. The information processing apparatus according to claim 1, wherein the map generator extracts the feature point used for the map based on the invariance of the feature point.

5. The information processing apparatus according to claim 1, further comprising:
an object recognition section that performs a recognition process of an object in the reference image,
wherein the invariance estimating section estimates the invariance of the feature point based on a kind of the object to which the feature point belongs.

6. The information processing apparatus according to claim 1, wherein the invariance of the feature point indicates a degree in which the feature point is less likely to change against at least one of lapse of time or change of environment.

7. The information processing apparatus according to claim 1, wherein the map includes a position, a feature amount, and the invariance of the feature point.

8. An information processing method comprising:
detecting a feature point in a reference image used for self-position estimation of a moving body;
estimating invariance of the feature point; and
generating a map based on the feature point and the invariance of the feature point.

9. A program for causing a computer to execute:
detecting a feature point in a reference image used for self-position estimation of a moving body;
estimating invariance of the feature point; and
generating a map based on the feature point and the invariance of the feature point.

10. A moving body comprising:
a feature point detector that detects a feature point in an observed image;
a feature point collation section that performs collation between a feature point in a map generated based on the feature point and invariance of the feature point and the feature point in the observed image; and
a self-position estimating section that performs self-position estimation based on a collation result between the feature point in the map and the feature point in the observed image.

11. The moving body according to claim 10, wherein the feature point collation section performs the collation between the feature point in the map and the feature point in the observed image while weighting based on invariance of the feature point in the map.

12. The moving body according to claim 10, wherein the feature point collation section performs the collation between a feature point whose invariance is more than or equal to a predetermined threshold among a plurality of the feature points in the map and the feature point in the observed image.

13. The moving body according to claim 10, wherein the invariance of the feature point indicates a degree in which the feature point is less likely to change against at least one of lapse of time or change of environment.
